(19) United States
(12) Patent Application Publication
(10) Pub. No.: US 2006/0188151 A1
(43) Pub. Date: Aug. 24, 2006

(54) Method for processing data for use with a video display of an imaging apparatus

(75) Inventors: James R. Bailey, Georgetown, KY (US); Christopher W. Case, Georgetown, KY (US); James A. Ward, Mayslick, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/063,795

(22) Filed: Feb. 23, 2005

(51) Int. Cl. G06K 9/00; G06K 9/36

(52) U.S. Cl. 382/166; 382/232

(57) ABSTRACT

A method for processing data for use with a video display includes compressing image data of one or more color planes on a line-by-line basis using lossy compression, wherein at least one lossy compression scheme of a plurality of lossy compression schemes is designated for each line of the plurality of lines to form compressed image data on the line-by-line basis.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates to an imaging apparatus, and, more particularly, to a method for processing data for use with a video display of an imaging apparatus.

2. Description of the Related Art

Liquid crystal displays (LCDs) are a common feature found on mid to high-end imaging apparatuses, such as for example, photo printers and multifunction devices (MFDs), which typically include scanner, printer and copier functionality. Such displays provide the user with the ability to preview images before printing and may also be used to add a high quality, menu-driven interface to control the imaging apparatus. For such products, a controller contained within the imaging apparatus is used to control the display and generate the images to be displayed. The controller may include, for example, one or more digital application specific integrated circuits (ASICs).

A typical LCD for interface applications may have a diagonal size, for example, of 2.5 inches and a resolution of at least 480 dots by 234 dots. Each dot is typically represented within the digital ASIC by an 8-bit (1 byte) value. Thus a typical LCD would require 112,320 bytes to fill the display. This data is sent to the LCD on average of 60 times per second to keep the image at the correct brightness and eliminate human-perceptible flicker of the display. To support this data rate, a dedicated memory such as a static random access memory (SRAM) may be provided to store the data locally within the digital ASIC of the controller. The data would then be read from the dedicated memory at the desired rate without impacting or affecting the performance of any other operation in the system. The dedicated memory utilized must be large enough to support various sized LCDs in order to provide the flexibility to support different types of LCD solutions. Utilizing a dedicated memory in the ASIC to store the LCD data can increase the cost of the ASIC substantially due to the size of such a memory increasing the overall required die area of the chip on which the ASIC is formed.

### SUMMARY OF THE INVENTION

The present invention, in one embodiment thereof, is directed to a method for processing data for use with a video display. The method includes compressing image data of one or more color planes on a line-by-line basis using lossy compression, wherein at least one lossy compression scheme of a plurality of lossy compression schemes is designated for each line of the plurality of lines to form compressed image data on the line-by-line basis.

The present invention, in another embodiment thereof, is directed to a method for processing data for use with a video display, including retrieving compressed image data from a memory; and decompressing the compressed image data on a line-by-line basis based on each designated compression scheme of a plurality of potential lossy compression schemes for each line of a plurality of lines to form decompressed image data.

The present invention, in another embodiment thereof, is directed to a method for processing data for use with a video display, including converting RGB color space input image data representing a plurality of lines of data to YCbCr color space image data; compressing the YCbCr color space image data of each color plane of the YCbCr color space on a line-by-line basis using lossy compression, wherein at least one lossy compression scheme of a plurality of lossy compression schemes is designated for each line of the plurality of lines to form compressed YCbCr color space image data on the line-by-line basis; storing the compressed YCbCr color space image data in a memory; retrieving the compressed YCbCr color space image data from the memory; decompressing the compressed YCbCr color space image data on the line-by-line basis based on each designated compression scheme for each line to form decompressed YCbCr color space image data; and converting the decompressed YCbCr color space image data to RGB color space output image data.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an imaging system embodying the present invention;

FIG. 2 is a flowchart of one embodiment of a method for processing data for use with a video display of an imaging apparatus in accordance with the present invention;

FIG. 3 shows an exemplary arrangement of two lines of compressed data in main memory in accordance with the present invention; and

FIG. 4 is an example of the use of a compression/decompression process of the present invention showing an input dataset of 15 bytes, a compressed dataset of 5 bytes, a compression type used for each group of data, and a decompressed dataset of 15 bytes.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION

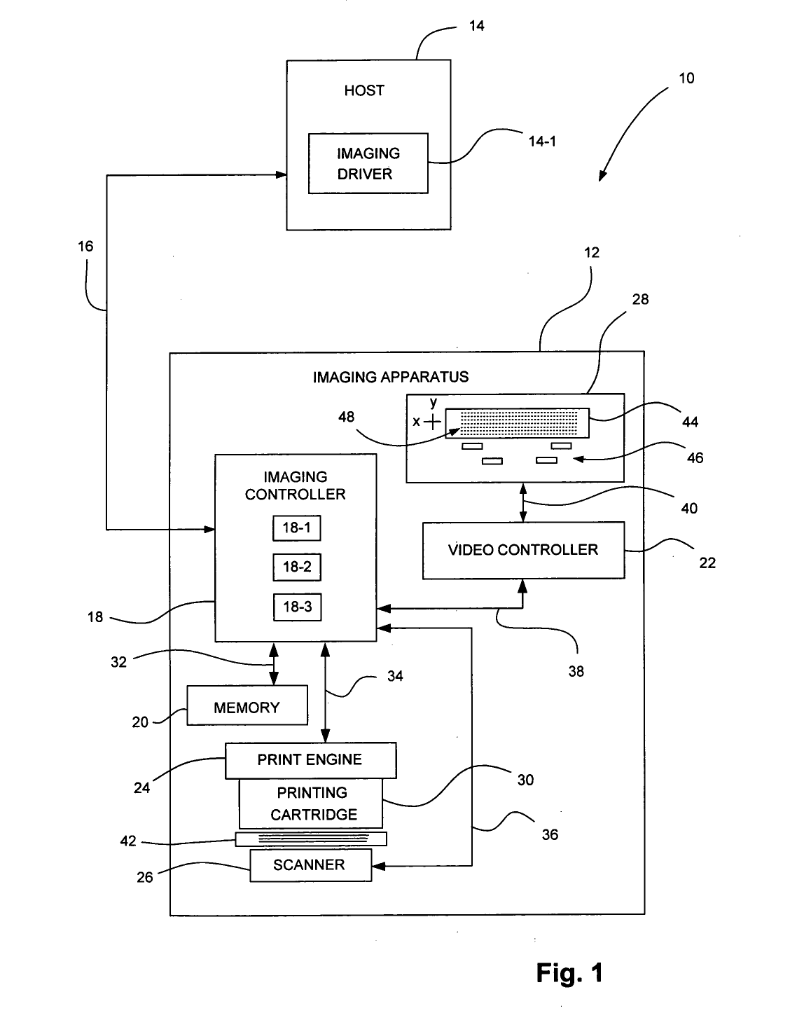

Referring now to the drawings and particularly to FIG. 1, there is shown a diagrammatic depiction of an imaging system 10 embodying the present invention. Imaging system 10 includes an imaging apparatus 12, and optionally a host 14.

In embodiments including host 14, imaging apparatus 12 communicates with host 14 via a communications link 16. As used herein, the term “communications link” is used to generally refer to structure that facilitates electronic communication between two components, and may operate using wired or wireless technology. For example, imaging apparatus 12 may communicate with host 14 over communications link 16 via a standard communication protocol, such as for example, universal serial bus (USB) or Ethernet. Host 14 may be, for example, a personal computer including a processor; input/output (I/O) interfaces; memory, such as random access memory (RAM), read only memory (ROM), and/or non-volatile RAM (NVRAM); an input device, such as a keyboard; and a display screen. Host 14 further may include at least one mass data storage device, such as a hard drive, a CD-ROM and/or a DVD unit. Host 14 includes in its memory a software program including program instructions that function as an imaging driver 14-1, e.g., printer/scanner driver software, for imaging apparatus 12. Imaging driver 14-1 facilitates communication between imaging apparatus 12 and host 14, and may provide formatted print data to imaging apparatus 12.

Imaging apparatus 12 may be, for example, an all-in-one (AIO) unit that includes printing, scanning, copying and possibly faxing functionality. An AIO unit is also known in the art as a multifunction device (MFD). Alternatively, imaging apparatus 12 may be a printer, such as for example, a photo printer. As shown in the embodiment of FIG. 1, imaging apparatus 12 includes an imaging controller 18, a memory 20, a video controller 22, a print engine 24, a scanner 26, and a user interface 28. A replaceable printing cartridge 30 containing an imaging substance, such as ink or toner, is coupled to print engine 24.

Imaging controller 18 includes a processor unit and internal memory, and may be formed as one or more Application Specific Integrated Circuits (ASIC). Imaging controller 18 further includes functional modules, such as for example, a color space converter 18-1, a compression module 18-2, and a decompression module 18-3. Imaging controller 18 serves to process image data and to operate print engine 24 during printing, as well as to operate scanner 26 and process image data obtained via scanner 26. Further, imaging controller 18 processes commands received from user interface 28, and supplies image data for display on video display 44 of user interface 28. Thus, imaging controller 18 may be a combined printer and scanner controller for respectively communicating with and controlling print engine 24 and scanner 26, and facilitates communication with user interface 28.

In the embodiment shown in FIG. 1, for example, imaging controller 18 communicates with memory 20 via communications link 32. Imaging controller 18 communicates with print engine 24 via a communications link 34. Imaging controller 18 communicates with scanner 26 via a communications link 36. User interface 28 is communicatively coupled to imaging controller 18 via a communications links 38, 40 and video controller 22. In some embodiments, it is contemplated that video controller 22 may be formed integral with imaging controller 18. In other embodiments, it is contemplated that communication links 32, 34, 36, 38 and 40 may be implemented as a single communications link connecting the various components are imaging apparatus 12.

Memory 20 serves as the main memory of imaging apparatus 12. Memory 20 may be, for example, random access memory (RAM), read only memory (ROM), non-volatile RAM (NVRAM), or any memory device convenient for use with imaging controller 18. Memory 20 may be used, for example, to store image data in compressed and/or decompressed form.

In the context of the examples for imaging apparatus 12 given above, print engine 24 may be, for example, an ink jet print engine, an electrophotographic print engine or a thermal transfer engine, configured for forming an image on a substrate 42, such as a sheet of paper, transparency, fabric or other material suitable for printing. As an ink jet print engine, for example, print engine 24 operates printing cartridge 30 to eject ink droplets onto substrate 42 in order to reproduce text and/or images. As an electrophotographic print engine, for example, print engine 24 causes printing cartridge 30 to deposit toner onto substrate 42, which is then fused to substrate 42 by a fuser (not shown), in order to reproduce text and/or images.

Scanner 26 is a conventional scanner, such as for example, a sheet feed or flat bed scanner. As is known in the art, a sheet feed scanner transports a sheet to be scanned past a stationary sensor device. In a flat bed scanner, the sheet or object to be scanned is held stationary, and a scanning bar including a sensor is scanned over the stationary sheet or object.

User interface 28 includes a video display 44 and an input mechanism 46, such as a plurality of input keys. Video display 44 may be, for example, an LCD having a diagonal size, for example, of about 2.5 inches and a resolution of about 480 dots (horizontal) by 234 dots (vertical). The 480×234 grid of dots are arranged as a plurality of vertically spaced lines 48, i.e., lines of dots, with each line extending horizontally in the orientation of the example shown. Each dot is typically represented by an 8-bit (1 byte) data value. RGB (red, green, blue) bit map data is supplied to video display 44 via video controller 22 to control each of the 112,320 dots forming the display. The bit map data may be sent to the video display 44 on average of 60 times per second to keep the image at the correct brightness and eliminate human-perceptible flicker of video display 44.

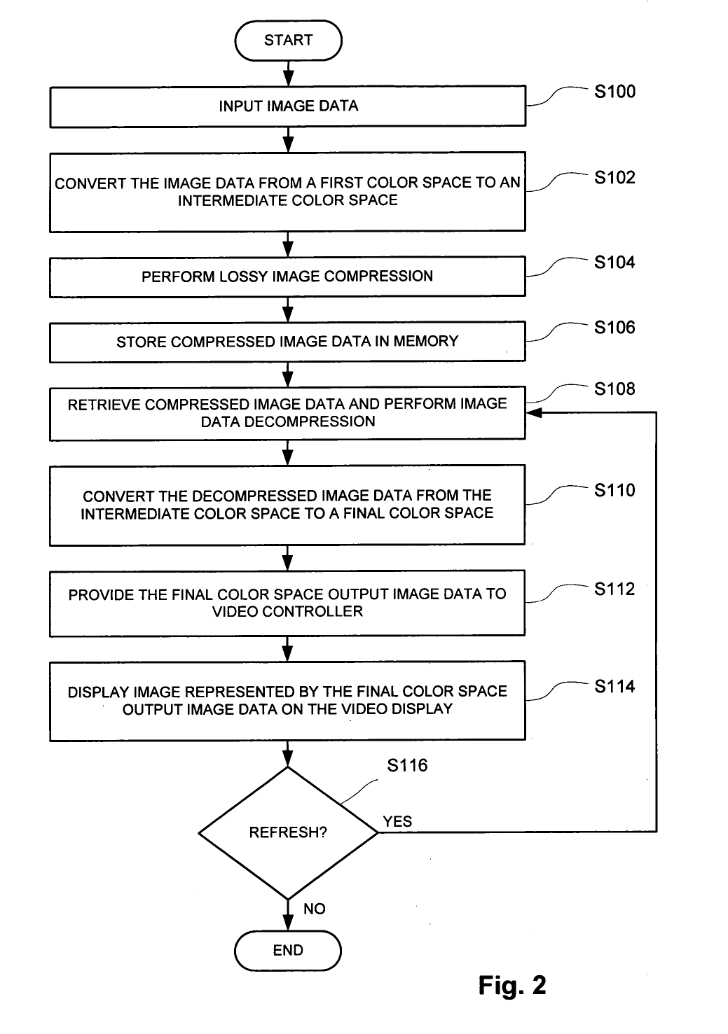

FIG. 2 is a flowchart of one embodiment of a method for processing data for use with video display 44 of imaging apparatus 12 in accordance with the present invention. In this example, the method is used to interface with video display 44, such as an LCD, and significantly reduces the amount of data that must be read from main memory, e.g., memory 20, to refresh the display 44 without impacting the quality of the images displayed.

At step S100, original color space image data is input for processing in accordance with the present invention. The source of the original color space input image data may be, for example, scanner 26. Alternatively, such original color space image data may, for example, have been received by imaging apparatus 12 from host 14. The original color space input image data may, if desired, may be stored upon receipt in memory 20. The original color space input image data may, for example, be in the form of RGB (red, green, blue) color space image data.

At step S102, the original or first color space input image data, e.g., the RGB color space input image data of step S100, representing a plurality of lines of data, is converted by color space converter 18-1 of imaging controller 18 to intermediate color space image data having a plurality of color planes. The intermediate color space may be, for example, YCbCr color space that includes a luminance plane Y, and two chrominance planes Cb and Cr, which are referred to herein for convenience as color planes.

In the present example, color space converter 18-1 of imaging controller 18 converts, for example, the original color space input image data in RGB color space to an intermediate YCbCr color space, converting separately each of the three color planes (i.e., the R color plane, the G color plane and the B color plane). Although YCbCr color space was utilized in the present embodiment as the intermediate color space, it is contemplated that the method of the present invention may be applied to other color space combinations.

At step S104, the intermediate color space image data of each color plane of the plurality of color planes is compressed by compression module 18-2 of imaging controller 18 on a line-by-line basis using lossy compression. At least one lossy compression scheme of a plurality of lossy compression schemes is designated for each line of the plurality of lines to form compressed intermediate color space image data on the line-by-line basis. In some circumstances multiple different lossy compression schemes will be used on a particular line of data. In the present example, each line extends from beginning to end in the horizontal, or x, direction, and multiple lines are arranged in parallel in the vertical, or y, direction, with respect to video display 44. Due to the nature of the YCbCr color space, for example, the chrominance planes (Cb, Cr) can often be compressed more aggressively than the luminance plane (Y), thereby minimizing the affect on the decompressed image quality while maximizing the compression ratio.

Video displays, such as video display 44, that may be used in association with the present invention typically refresh at a rate of about 60 times per second. In order to reduce main memory bandwidth without increasing ASIC cost, it is desirable to compress, and decompress, in one direction only, e.g., horizontally only in the x direction, as compared to some compression algorithms that compress in both the horizontal (x) direction and the vertical (y) direction. Compression only in the x direction avoids buffering multiple lines for use during decompression, and thereby decreases ASIC costs.

At step S106, the compressed intermediate color space image data is stored in main memory, e.g., memory 20.

At step S108, the compressed intermediate color space image data stored in main memory 20 is retrieved. The compressed intermediate color space image data, e.g., YCbCr color space image data, is then decompressed by decompression module 18-3 of imaging controller 18 on a line-by-line basis based on each designated compression scheme for each line to form decompressed intermediate color space image data. Considering that video controllers for multifunctional devices and photo printer applications do not require motion video, the same image will be sent to video display 44 many times. Thus, the image will be decompressed many more times than it will be compressed, making a quick, low overhead decompression method desirable, as will be discussed in further detail below.

At step S110, the decompressed intermediate color space image data is converted to final color space output image data, e.g., converted to RGB final color space output image data.

At step S112, the final color space output image data is provided to the video controller 22 for conversion to bit map data to control individual dots of video display 44.

At step S114, the image represented by the final color space output image data is displayed on video display 44.

At step S116, it is determined whether the video display is to be refreshed with the current image data, and if YES, then the process returns to step S108. Otherwise, the process ends, and restarts at step S100 to process new image data.

In practicing the present invention, the resulting image displayed on video display 44 substantially maintains the visual quality of the original image, while greatly reducing the performance impact on, for example, print engine 24 and/or scanner 26, compared to traditional techniques. The method described above provides a fully flexible, low overhead solution to interfacing various types of video displays, such as LCDs. In addition to minimizing the amount of memory bandwidth-consumed by video display 44 over that of a traditional video system, the amount of memory storage required for each displayed image is reduced, thereby allowing a multitude of compressed display images to be stored in memory 20 and retrieved when desired.

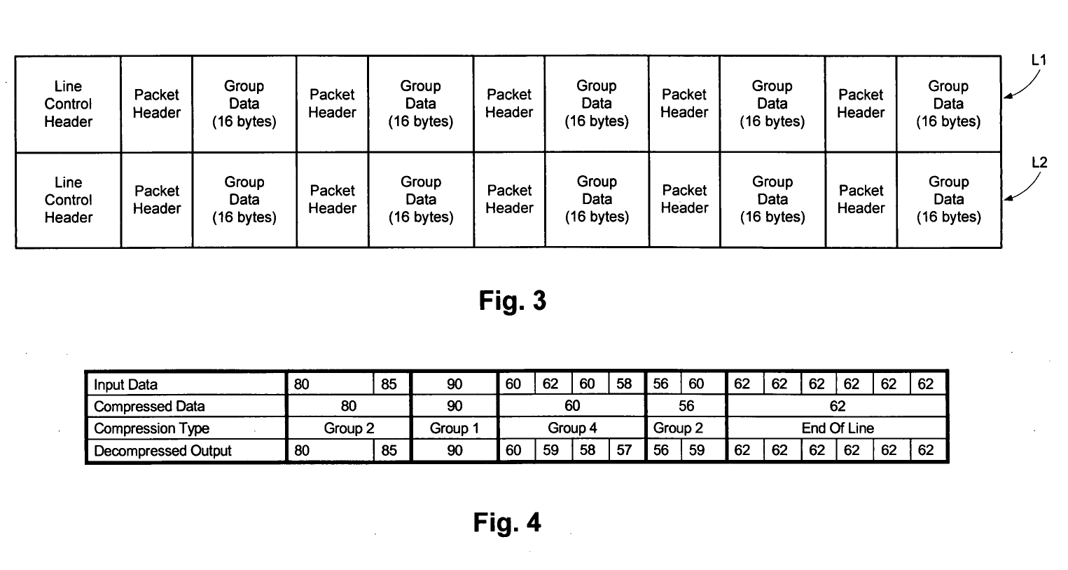

FIG. 3 shows an exemplary arrangement of two lines, L1 and L2, of compressed data in main memory 20 in accordance with the present invention. In this example, a line control header is inserted in the data stream at the beginning of each of line L1 and line L2 of compressed data. The decompression module 18-3 of image controller 18 (see step S108 of FIG. 2) then utilizes the line control header to determine what decompression schemes may be used for the entire line. Since there is a line control header for each line, then each line can utilize different methods of compression to optimize the size of the compressed image and the quality of the decompressed image.

In addition to a line control header, each group of sixteen compressed bytes, referred to as group data, forms a compression packet, will contain a packet header. Utilizing packetized compression in accordance with the present invention allows the image to be dynamically compressed to minimize the size of the compressed image without degrading the quality of the decompressed image. The packet header contains information on how the sixteen bytes of group data were compressed. In one embodiment, for example, a packet header may contain a two-bit field for each group data compression packet of sixteen bytes to indicate one of up to four different compression schemes used to compress that group data compression packet. Thus, the line control header specifies the compression schemes that are available, and the packet header specifies the actual compression scheme used in compressing a particular group data compression packet. Accordingly, multiple different compression schemes may be used on a single line of data.

For example, the line control header may specify that if the two-bit field in the packet header is equal to “01”, then a 16:1 sub-sampling compression scheme is used for the corresponding bytes of data. The line control header contains encoded bit fields, which direct the packet headers to use the specified compression scheme.

One exemplary compression scheme available on a line-by-line basis is referred to herein as color depth reduction. For example, by reducing each 8-bit value to a 4-bit value a 2:1 compression is achieved. For lines of low color depth such as menu background colors, this provides quick, high quality compression. For photographs, this compression scheme is often not desirable due to the loss of color depth. Since a mixture of photographs and menus is often displayed on multifunction devices (MFDs) and photo printer displays, such as video display 44, certain regions in the image to be displayed may be able to take advantage of this type of compression. The line control packet allows these regions to be compressed optimally without affecting other areas of the image. One exemplary implementation for the color depth reduction compression scheme is to clip the lower 4-bits of data to zeroes. However, a color palette could be utilized to maximize the quality of a line compressed in this manner.

Another exemplary compression scheme available on a line-by-line basis is referred to herein as unidirectional byte sub-sampling. For this compression scheme, neighboring byte values are compared to one another in the x direction, and if they have similar values only the first value for each group is placed in the compressed data stream. The cutoff point for determining if bytes are similar is variable, thereby allowing a continuum of quality versus compression. The actual values of the cutoffs can be determined experimentally depending on the desired quality and compression ratio. In practice, the chrominance planes Cb, Cr of a YCbCr image will have a higher threshold for determining if neighboring bytes can be subsampled than the luminance plane Y. This reduces the amount of data in the chrominance planes Cb, Cr since they have far less of an impact on the image quality than the luminance plane Y. The size of the groups may be fixed on a line-by-line basis and this group size information is inserted into the line control header.

In the embodiment of FIG. 4, for example, four distinct group sizes are supported. As the input data is grouped, the selected group size is encoded and placed in the packet header. Because there are four possible groups, a two-bit field within the packet header is required for each group, allowing for sixteen groups to be described by a single 32-bit packet control word. In this embodiment, the decompression module utilizes linear interpolation to approximate the removed bytes in the decompressed image. To clarify, linear interpolation is used to calculate the missing bytes between each of the stored bytes in the compressed packet. The group size information in the line control header and packet header determines how many bytes should be restored between stored bytes during decompression.

Still another exemplary method of reducing display data on a line-by line basis is by repeating a byte until the end of a line, and is referred to herein as an end-of-line compression scheme. This is implemented as an extension of the unidirectional byte sub-sampling scheme described above. One of the four options in the line control word is designated as an end of line group. The one byte of data that was inserted into the compressed data stream is then repeatedly sent to the display until the end of the line is reached. This allows a line to be compressed from left to right and an end of line group to be inserted when there is no more changing data for the rest of that line. This option is especially effective on graphical user interfaces where a solid background can be represented with a few bytes per line. In addition to the three compression methods described above, additional methods could be added by one skilled in the art to optimize compression utilizing the techniques described above.

An example of the end-of-line compression scheme follows immediately below. For this example group sizes of 1 byte, 2 bytes, 4 bytes, and end of line are chosen for the compressed line. Cutoffs for the following groups are shown in Table 1, below. The Group Size column corresponds to identifiers that will be stored in the line control header and specifies the options to how each group of dots can be compressed.

TABLE 1
Line Control Packet Information

| Group Size | Cutoff |
|---|---|
| 1 | 10 |
| 2 | 5 |
| 4 | 2 |
| EOL | 0 |

FIG. 4 is an example of the use of a compression/decompression process of the present invention showing an input dataset of 15 bytes, a compressed dataset of 5 bytes, a compression type used for each group of data, and a decompressed dataset of 15 bytes. Group sizes should be maximized to achieve the highest compression. This example shows the lossy nature of this compression/decompression scheme, but with some experimentation on cutoff values the degradation observed on video display 44 will be minimal. For example, more loss is visually acceptable in the chrominance planes Cb, Cr than in the luminance plane Y of the YCbCr color space data therefore the cutoff values used for the chrominance planes can be higher value allowing more data to be grouped together.

Cutoff values are used to determine group sizes and relate to the maximum difference in value between successive input data values for group forming purposes. For the input data shown in FIG. 4, there is a difference of 5 between the first input data byte of 80 and the second input data byte of 85 allowing the first and second input data bytes to form a group of 2. The third and fourth input data bytes have values of 90 and 60 with a difference of 30. Thus the third byte forms a group of 1. The difference between the each of the next five input data values beginning with the fourth input data byte is 2; however, for a cutoff value or difference of two the maximum group size is 4 meaning that the fourth, fifth, sixth, and seventh data values form a group of 4. The eight and ninth input data bytes have values of 56 and 60 with a difference of 4 and thus form a group of 2. The tenth through fifteenth input data bytes each have a value of 62 with a difference of 0 and thus fall into the End of Line group.

Stored for each compressed line is first a line control header, which directs decompression module 18-3 to utilize decompression using groupings of one, groupings of two, groupings of four, or end-of-line groupings as shown in the first column of Table 1 when directed by each packet header. In this example, the packet header will contain a “Group 2” code corresponding to the first byte of compressed data (having a value of 80) as shown in FIG. 4. Then, the packet header will contain a “Group 1” code for the second compressed byte (having a value of compressed value of 90 which is the same value as the initial input value) followed by a “Group 4” code (having a compressed value of 60), a “Group 2” code (having a compressed value of 56), and a “End of Line” code (having a compressed value of 62) for the third, fourth, and fifth compressed bytes, respectively.

Each packet header has only four decompression choices in this implementation, those choices being selected from the line control header. Decompression module 18-3 of imaging controller 18 will read the line control header and corresponding packet header and decompress the data as shown in FIG. 4 using linear interpolation. In the example shown in FIG. 4 for the first and second groups of input data and decompressed output data no loss occurred between the input data and the decompressed output data. However for the third and fourth groups the effect of the lossy compression technique is in evidence as a difference can be seen between the input data values of 60, 62, 60, 58, 56, and 60 and the respective corresponding decompressed output values of 60, 59, 58, 57, 56, and 59 generated by using linear interpolation.

The example of FIG. 4 shows how the data can be compressed by a factor of 3:1 depending on the input data. In practice, an image will exhibit a compression ratio of anywhere from 2:1 to 10:1 based on the aggressiveness of the compression and the characteristics of the image itself.

Accordingly, the present invention significantly reduces the amount of required memory bandwidth while maintaining full flexibility to support a variety of displays. The present invention also reduces the amount of system memory storage required for each stored image minimizing the memory requirements for storing a large number of images to be displayed. The input image is compressed using a packetized unidirectional compression scheme that can be decompressed quickly while minimizing hardware overhead. Utilizing this type of packetized compression allows the quality of the decompressed image to be maintained while the size of the compressed image is optimized. In practice, the compression ratios achieved and the quality of the decompressed images rival that of more traditional compression methods.

The present invention may be utilized, for example, to display the image as it is being scanned during a standalone copy operation (host free) of imaging apparatus 12 to allow the user to see the progress of the scan without lifting the cover. Or, the present invention may be utilized to store a large number of image thumbnails from a camera card given the physical on-board memory limitations so that a user can quickly browse through multiple images while one is being printed in a standalone environment. The present invention may also be used to generate menus on user interface 28 to guide the user through the operation of imaging apparatus 12.

The foregoing description of several methods and embodiments of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A method for processing data for use with a video display, comprising:
compressing image data of one or more color planes on a line-by-line basis using lossy compression, wherein at least one lossy compression scheme of a plurality of lossy compression schemes is designated for each line of a plurality of lines to form compressed image data on said line-by-line basis.

2. The method of claim 1, wherein said image data is intermediate color space image data, the method further comprising:
converting first color space input image data representing said plurality of lines of data to said intermediate color space image data having a plurality of color planes; and
wherein the step of compressing includes compressing said intermediate color space image data of each color plane of said plurality of color planes on said line-by-line basis using said lossy compression to form compressed intermediate color space image data on said line-by-line basis.

3. The method of claim 2, wherein said intermediate color space image data is YCbCr intermediate color space image data, said plurality of color planes including a luminance plane and two chrominance planes.

4. The method of claim 2, further comprising storing said compressed intermediate color space image data in a memory.

5. The method of claim 4, further comprising:
retrieving said compressed intermediate color space image data from said memory;
decompressing said compressed intermediate color space image data on said line-by-line basis based on each designated compression scheme for each line to form decompressed intermediate color space image data; and
converting said decompressed intermediate color space image data to final color space output image data.

6. The method of claim 5, wherein said final color space output image data is RGB color space output image data.

7. The method of claim 5, further comprising generating an image on said video display based on said final color space output image data.

8. The method of claim 1, wherein said at least one lossy compression scheme includes color depth reduction compression, wherein a subset of a plurality of bits representing a portion of data is clipped.

9. The method of claim 1, wherein said at least one lossy compression scheme includes unidirectional byte sub-sampling compression, wherein neighboring dots represented along a particular line of said plurality of lines are compared for similar values.

10. The method of claim 1, wherein said at least one lossy compression scheme includes end-of line compression, wherein a byte is repeated until the end of a particular line of said plurality of lines.

11. A method for processing data for use with a video display, comprising:
retrieving compressed image data from a memory; and
decompressing said compressed image data on a line-by-line basis based on each designated compression scheme of a plurality of potential lossy compression schemes for each line of a plurality of lines to form decompressed image data.

12. The method of claim 11, said decompressed image data being in a predetermined color space, the method further comprising:
converting said decompressed image data in said predetermined color space to final color space output image data.

13. The method of claim 12, further comprising generating an image on said video display based on said final color space output image data.

14. The method of claim 12, wherein said final color space output image data is RGB color space output image data.

15. The method of claim 11, wherein said plurality of potential lossy compression schemes includes color depth reduction compression, wherein a subset of a plurality of bits representing a portion of data is clipped.

16. The method of claim 11, wherein said plurality of potential lossy compression schemes includes unidirectional byte sub-sampling compression, wherein neighboring dots represented along a particular line of said plurality of lines are compared for similar values.

17. The method of claim 11, wherein said plurality of potential lossy compression schemes includes end-of line compression, wherein a byte is repeated until the end of a particular line of said plurality of lines.

18. A method for processing data for use with a video display, comprising:
converting RGB color space input image data representing a plurality of lines of data to YCbCr color space image data;
compressing said YCbCr color space image data of each color plane of said YCbCr color space on a line-by-line basis using lossy compression, wherein at least one lossy compression scheme of a plurality of lossy compression schemes is designated for each line of said plurality of lines to form compressed YCbCr color space image data on said line-by-line basis;
storing said compressed YCbCr color space image data in a memory;
retrieving said compressed YCbCr color space image data from said memory;
decompressing said compressed YCbCr color space image data on said line-by-line basis based on each designated compression scheme for each line to form decompressed YCbCr color space image data; and
converting said decompressed YCbCr color space image data to RGB color space output image data.

19. The method of claim 18, further comprising generating an image on said video display based on said RGB color space output image data.

20. The method of claim 18, wherein said plurality of lossy compression schemes includes:
color depth reduction compression, wherein a subset of a plurality of bits representing a portion of data is clipped;
unidirectional byte sub-sampling compression, wherein neighboring dots represented in said plurality of lines are compared for similar values; and
end-of line compression, wherein a byte is repeated until the end of a particular line of said plurality of lines.
